(19) United States
(12) Patent Application Publication
(10) Pub. No.: US 2022/0156853 A1
(43) Pub. Date: May 19, 2022

(54) METHOD AND SYSTEM FOR SELECTING SINGLE TARGET NODE WITHIN SOCIAL NETWORK

(71) Applicant: NATIONAL TSING HUA UNIVERSITY, Hsinchu (TW)

(72) Inventor: Wei-Chang YEH, Hsinchu (TW)

(21) Appl. No.: 17/226,066

(22) Filed: Apr. 8, 2021

(30) Foreign Application Priority Data
Nov. 18, 2020 (TW) 109140386

(51) Int. Cl. G06Q 50/00; H04L 12/58; G06N 7/00

(52) U.S. Cl. CPC G06Q 50/01; G06N 7/005; H04L 51/32

(57) ABSTRACT

A method for selecting single target node within a social network is configured to select the single target node and deliver a message. A node providing step is performed to set one of nodes within the social network as a source node. A probability calculating step is performed to calculate a plurality of propagation-node numbers of the source node according to a Monte Carlo module and a layered-search module. An expected value generating step is performed to generate an expected value according to the propagation-node numbers and a plurality of propagating success probabilities. A target node selecting step is performed to reset another of the nodes as the source node and repeat the probability calculating step and the expected value generating step to generate another expected value, and compare the expected value with the another expected value to select the single target node having a maximum expected value.

### RELATED APPLICATIONS

This application claims priority to Taiwan Application Serial Number 109140386, filed Nov. 18, 2020, which is herein incorporated by reference.

### BACKGROUND

### Technical Field

The present disclosure relates to a method and a system for selecting a target node. More particularly, the present disclosure relates to a method and a system for selecting a single target node within a social network.

### Description of Related Art

In recent years, opportunities and frequency of the interactions between people have increased dramatically with the increasing popularity of Internet. Internet is composed of at least one network server. The network server is generally referred to as a social network server (SNS). The interaction between users in the social network server can be called a social network that is why the social network has become the mainstream media for delivering information on the Internet, such as: Facebook (FB), Twitter, LINE or WeChat.

On a large-scale social network, each of users can be represented by a node. Advertisers try to find a suitable node in the social network as a target and deliver a message to the target so as to achieve the greatest click rate or the greatest propagation rate. However, sending messages to all the nodes in the social network will consume a huge amount of time and cost.

In view of this, the current market lacks a node selecting method and a node selecting system which can achieve the largest click rate or the greatest propagation rate by delivering the message to single node in the social network. The node selecting method and the node selecting system are highly anticipated by the public and become the goal and the direction of relevant industry efforts.

### SUMMARY

According to one aspect of the present disclosure, a method for selecting a single target node within a social network is configured to select the single target node in the social network and deliver a message. The method for selecting the single target node within the social network includes a node providing step, a probability calculating step, an expected value generating steps and a target node selecting step. The node providing step is performed to obtain the social network including a plurality of nodes, and drive a processing unit to set one of the nodes as a source node. The probability calculating step is performed to drive the processing unit to calculate a plurality of propagation-node numbers of the source node according to a Monte Carlo module and a layered-search module. Each of the propagation-node numbers is corresponding to a propagating success probability. The expected value generating step is performed to drive the processing unit to generate an expected value according to the propagation-node numbers and the propagating success probabilities of the propagation-node numbers. The target node selecting step is performed to drive the processing unit to reset another of the nodes as the source node and repeat the probability calculating step and the expected value generating step to generate another expected value, and compare the expected value with the another expected value to select the single target node having a maximum expected value.

According to another aspect of the present disclosure, a system for selecting a single target node within a social network is configured to select the single target node in the social network and deliver a message. The system for selecting the single target node within the social network includes a memory and a processing unit. The memory is configured to access the social network, a Monte Carlo module and a layered-search module. The social network includes a plurality of nodes. The processing unit is electrically connected to the memory. The processing unit receives the social network and is configured to implement a method for selecting the single target node within the social network including performing a node providing step, a probability calculating step, an expected value generating step and a target node selecting step. The node providing step is performed to obtain the social network from the memory and drive the processing unit to set one of the nodes as a source node. The probability calculating step is performed to drive the processing unit to calculate a plurality of propagation-node numbers of the source node according to the Monte Carlo module and the layered-search module. Each of the propagation-node numbers is corresponding to a propagating success probability. The expected value generating step is performed to drive the processing unit to generate an expected value according to the propagation-node numbers and the propagating success probabilities of the propagation-node numbers. The target node selecting step is performed to drive the processing unit to reset another of the nodes as the source node and repeat the probability calculating step and the expected value generating step to generate another expected value, and compare the expected value with the another expected value to select the single target node having a maximum expected value.

### BRIEF DESCRIPTION OF THE DRAWINGS

The present disclosure can be more fully understood by reading the following detailed description of the embodiment, with reference made to the accompanying drawings as follows:

FIG. 1 shows a flow chart of a method for single target node within a social network according to an embodiment of the present disclosure.

FIG. 2 shows a flow chart of a probability calculating step of FIG. 1.

FIG. 3 shows another flow chart of the probability calculating step of FIG. 1.

FIG. 4 shows a schematic view of the social network of the present disclosure.

FIG. 5 shows a schematic view of a node set of the social network of FIG. 4.

FIG. 6 shows a schematic view of another node set of the social network of FIG. 4.

FIG. 7 shows a block diagram of a system for the single target node within the social network according to another embodiment of the present disclosure.

### DETAILED DESCRIPTION

The embodiment will be described with the drawings. For clarity, some practical details will be described below. However, it should be noted that the present disclosure should not be limited by the practical details, that is, in some embodiment, the practical details is unnecessary. In addition, for simplifying the drawings, some conventional structures and elements will be simply illustrated, and repeated elements may be represented by the same labels.

It will be understood that when an element (or device) is referred to as be “connected to” another element, it can be directly connected to the other element, or it can be indirectly connected to the other element, that is, intervening elements may be present. In contrast, when an element is referred to as be “directly connected to” another element, there are no intervening elements present. In addition, the terms first, second, third, etc. are used herein to describe various elements or components, these elements or components should not be limited by these terms. Consequently, a first element or component discussed below could be termed a second element or component.

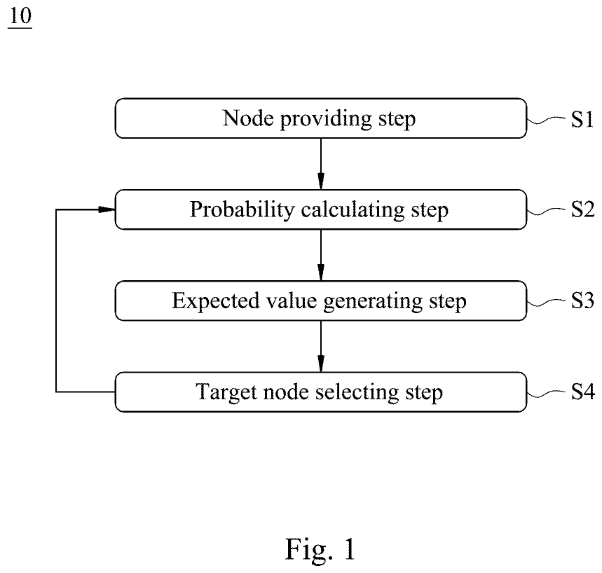

FIG. 1 shows a flow chart of a method for single target node within a social network according to an embodiment of the present disclosure. In FIG. 1, the method 10 for the selecting single target node within the social network is configured to select the single target node in the social network and deliver a message. The method 10 for selecting the single target node within the social network includes a node providing step S1, a probability calculating step S2, an expected value generating steps S3 and a target node selecting step S4.

The node providing step S1 is performed to obtain the social network including a plurality of nodes, and drive a processing unit to set one of the nodes as a source node.

The probability calculating step S2 is performed to drive the processing unit to calculate a plurality of propagation-node numbers of the source node according to a Monte Carlo module and a layered-search module. Each of the propagation-node numbers is corresponding to a propagating success probability.

The expected value generating step S3 is performed to drive the processing unit to generate an expected value according to the propagation-node numbers and the propagating success probabilities of the propagation-node numbers.

The target node selecting step S4 is performed to drive the processing unit to reset another of the nodes as the source node and repeat the probability calculating step S2 and the expected value generating step S3 to generate another expected value, and compare the expected value with the another expected value to select the single target node having a maximum expected value.

Therefore, the method 10 for selecting the single target node within the social network calculates the expected value of each of the nodes of the social network, and selects the single target node having the maximum expected value from the nodes to deliver the message, so that the message in the social network achieves the maximum propagation-node number so as to increase the propagation rate of the message.

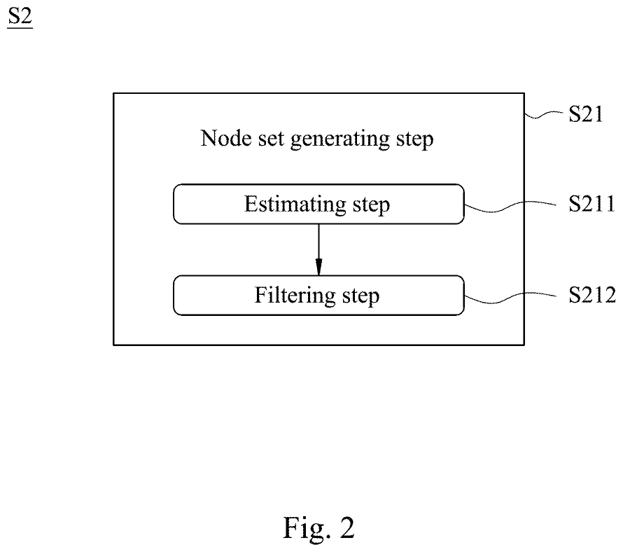

Please refer to FIGS. 1 and 2. FIG. 2 shows a flow chart of the probability calculating step S2 of FIG. 1. In FIG. 2, the probability calculating step S2 can include a node set generating step S21. The node set generating step S21 is implemented by the processing unit and includes performing an estimating step S211 and a filtering step S212. The estimating step S211 is performed to estimate a simulated propagating probability between each of the nodes and another of the nodes adjacent to the each of the nodes according to the Monte Carlo module. In addition, an actual propagating probability between each of the nodes and another of the nodes adjacent to the each of the nodes is generated. The filtering step S212 is performed to filter the actual propagating probabilities among the nodes according to the simulated propagating probabilities among the nodes to generate a plurality of node sets corresponding to the source node, respectively.

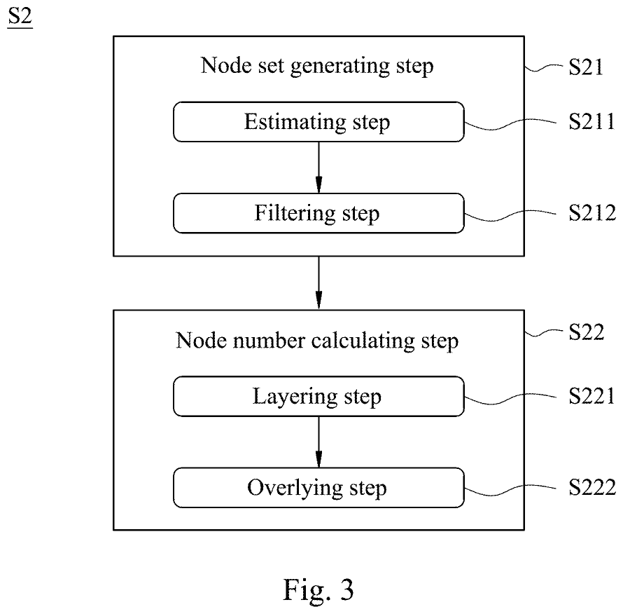

Please refer to FIGS. 1 and 3. FIG. 3 shows another flow chart of the probability calculating step S2 of FIG. 1. In FIG. 3, the probability calculating step S2 can include a node set generating step S<and a node number calculating step S22. The node set generating step S21 of FIG. 3 is the same as the node set generating step S21 of FIG. 2, and will not be detailedly described herein. The node number calculating step S22 is implemented by the processing unit and includes performing a layering step S221 and an overlying step S222. The layering step S221 is performed to cut one of the node sets according to the layered-search module to generate an ith propagation layer and an i+1th propagation layer. The overlying step S222 is performed to overlay the ith propagation layer and the i+1th propagation layer according to the layered-search module to calculate one of the propagation-node numbers.

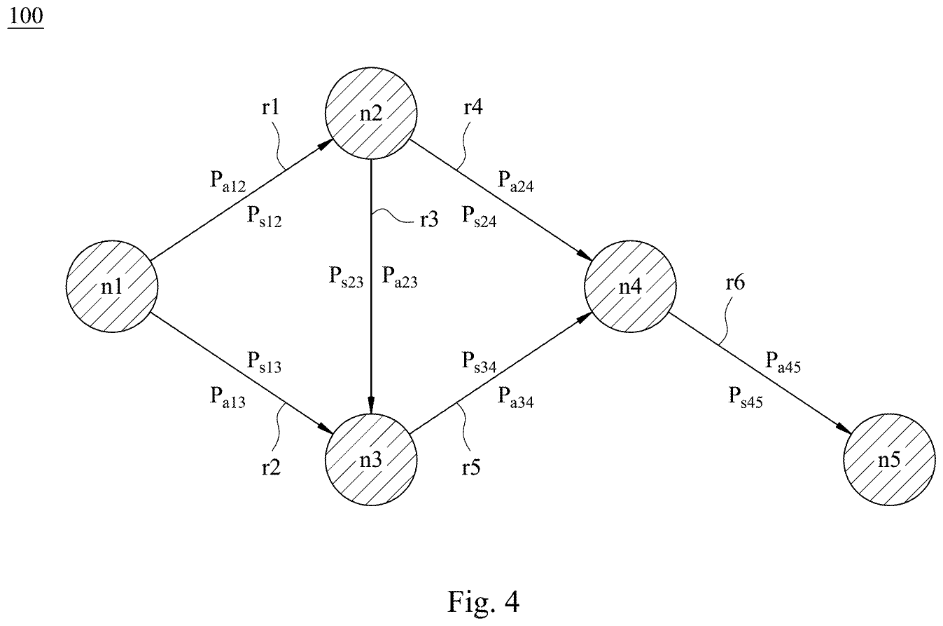

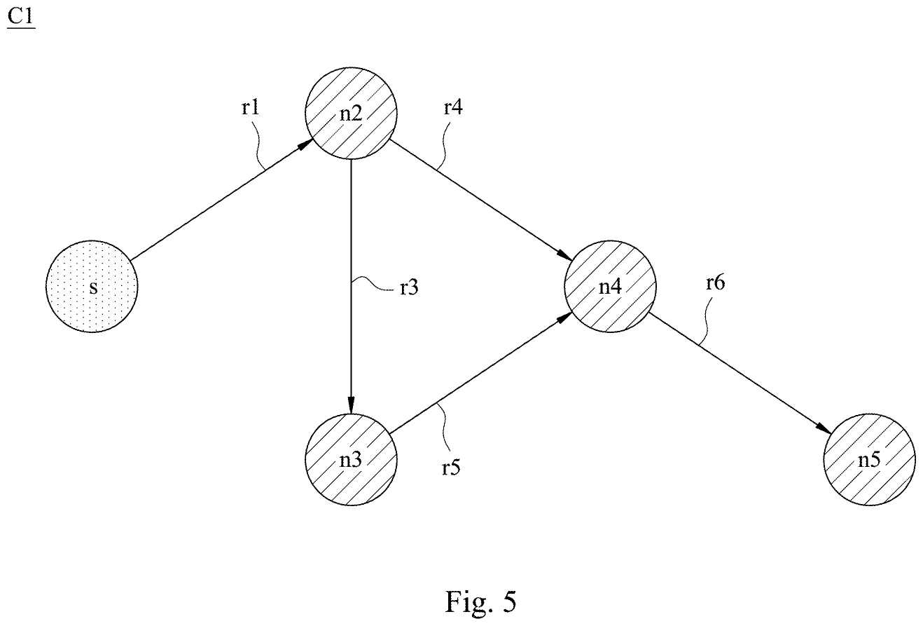

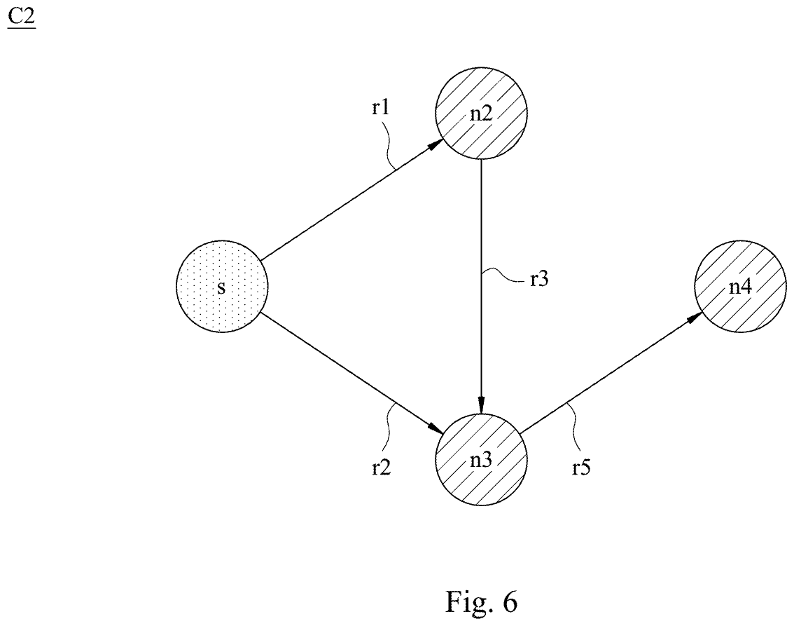

Please refer to FIGS. 1, 2, 3, 4, 5 and 6. FIG. 4 shows a schematic view of the social network 100 of the present disclosure. FIG. 5 shows a schematic view of a node set C1 of the social network 100 of FIG. 4. FIG. 6 shows a schematic view of another node set C2 of the social network 100 of FIG. 4. In FIGS. 1 to 6, the social network 100 includes the nodes n1, n2, n3, n4, n5 and a plurality of paths r1, r2, r3, r4, r5, r6.

In detail, the path r1 of FIG. 4 represents that the node n1 transmits the message to the node n2, and the actual propagating probability Pₐ₁₂ between the node n1 and the node n2 is generated according to the path r1. The path r2 of FIG. 4 represents that the node n1 transmits the message to the node n3, and the actual propagating probability Pₐ₁₃ between the node n1 and the node n3 is generated according to the path r2. The path r3 of FIG. 4 represents that the node n2 transmits the message to the node n3, and the actual propagating probability Pₐ₂₃ between the node n2 and the node n3 is generated according to the path r3. The path r4 of FIG. 4 represents that the node n2 transmits the message to the node n4, and the actual propagating probability Pₐ₂₄ between the node n2 and the node n4 is generated according to the path r4. The path r5 of FIG. 4 represents that the node n3 transmits the message to the node n4, and the actual propagating probability Pₐ₃₄ between the node n3 and the node n4 is generated according to the path r5. The path r6 of FIG. 4 represents that the node n4 transmits the message to the node n5, and the actual propagating probability Pₐ₄₅ between the node n4 and the node n5 is generated according to the path r6. Since the social network 100 can be a scale-free network, a number of the nodes n1, n2, n3, n4, n5, a number of the paths r1, r2, r3, r4, r5, r6 and the actual propagating probabilities Pₐ₁₂, Pₐ₁₃, Pₐ₂₃, Pₐ₂₄, Pₐ₃₄, Pₐ₄₅ during the social network 100 propagating the message are not limited to the embodiment of FIG. 4.

Particularly, in the node providing step S1, the processing unit sets the node n1 as the source node s of the social network 100 (as shown in FIG. 5), that is, the starting point of delivering the message, and then the node set generating step S21 is performed. In the estimating step S211, the processing unit executes the first Monte Carlo Simulation (MCS) according to the Monte Carlo module and estimates the corresponding simulated propagating probabilities Pₛ₁₂, Pₛ₁₃, Pₛ₂₃, Pₛ₂₄, Pₛ₃₄, Pₛ₄₅ of the paths r1, r2, r3, r4, r5, r6.

Please refer to FIGS. 4, 5 and the following Table 1. Table 1 lists the actual propagating probabilities Pₐ₁₂, Pₐ₁₃, Pₐ₂₃, Pₐ₂₄, Pₐ₃₄, Pₐ₄₅ and the simulated propagating probabilities Pₛ₁₂, Pₛ₁₃, Pₛ₂₃, Pₛ₂₄, Pₛ₃₄, Pₛ₄₅ of the paths r1, r2, r3, r4, r5, r6 in the first Monte Carlo Simulation, but the present disclosure is not limited thereto.

TABLE 1

| | r1 | r2 | r3 | r4 | r5 | r6 |
|---|---|---|---|---|---|---|
| Actual propagating | 0.8 | 0.6 | 0.7 | 0.8 | 0.5 | 0.4 |
| probability | | | | | | |
| Simulated propagating | 0.7 | 0.7 | 0.5 | 0.7 | 0.4 | 0.2 |
| probability | | | | | | |

In the filtering step S 212, the processing unit filters the actual propagating probabilities Pₐ₁₂, Pₐ₁₃, Pₐ₂₃, Pₐ₂₄, Pₐ₃₄, Pₐ₄₅ according to the simulated propagating probabilities Pₛ₁₂, Pₛ₁₃, Pₛ₂₃, Pₛ₂₄, Pₛ₃₄, Pₛ₄₅ to generate the node set C1 corresponding to the source node s, respectively. The node set C1 includes the source nodes (i.e., the node n1) and the nodes 2, n3, n4, n5. In detail, the actual propagating probability Pₐ₁₂ is greater than the simulated propagating probability Pₛ₁₂, so that the path r1 can propagate the message. The actual propagating probability Pₐ₁₃ is less than the simulated propagating probability Pₛ₁₃, and the path r2 cannot propagate the message. Similarly, all of the paths r3, r4, r5, r6 can propagate the message. Therefore, the message can propagate from the source node s to the nodes n2, n3, n4, n5 through the paths r1, r3, r4, r5, r6.

Please refer to FIGS. 4, 6 and the following Table 2. In the estimating step S211, the processing unit executes the second Monte Carlo Simulation according to the Monte Carlo module and estimates the corresponding simulated propagating probabilities Pₛ₁₂, Pₛ₁₃, Pₛ₂₃, Pₛ₂₄, Pₛ₃₄, Pₛ₄₅ of the paths r1, r2, r3, r4, r5, r6. Table 2 lists the actual propagating probabilities Pₐ₁₂, Pₐ₁₃, Pₐ₂₃, Pₐ₂₄, Pₐ₃₄, Pₐ₄₅ and the simulated propagating probabilities Pₛ₁₂, Pₛ₁₃, Pₛ₂₃, Pₛ₂₄, Pₛ₃₄, Pₛ₄₅ of the paths r1, r2, r3, r 4, 5, r6 in the second Monte Carlo Simulation, but the present disclosure is not limited thereto.

TABLE 2

| | r1 | r2 | r3 | r4 | r5 | r6 |
|---|---|---|---|---|---|---|
| Actual propagating | 0.8 | 0.6 | 0.7 | 0.8 | 0.5 | 0.4 |
| probability | | | | | | |
| Simulated propagating | 0.4 | 0.5 | 0.6 | 0.9 | 0.3 | 0.7 |
| probability | | | | | | |

In the filtering step S212, the processing unit filters the actual propagating probabilities Pₐ₁₂, Pₐ₁₃, Pₐ₂₃, Pₐ₂₄, Pₐ₃₄, Pₐ₄₅ according to the simulated propagating probabilities Pₛ₁₂, Pₛ₁₃, Pₛ₂₃, Pₛ₂₄, Pₛ₃₄, Pₛ₄₅ to generate the another node set C2 corresponding to the source node s, respectively. The node set C2 includes the source node s and the nodes n2, n3, n4, and so on. The processing unit executes the Monte Carlo Simulation multiple times based on the node n1 as the source node s, and obtains the node sets corresponding to the node n1.

Then, the node number calculating step S22 is performed. In the layering step S221, the processing unit executes a layered-search method according to the layered-search module. The layered-search method cuts the node set C1 corresponding to the node 1 to generate the ith propagation layer and the i+1th propagation layer. In the overlying step S222, the layered-search method overlays the ith propagation layer and the i+1th propagation layer to calculate the propagation-node number of the node n1. In detail, the layered-search method calculates the propagation-node number by counting a node number of each of the nodes n1, n2, n3, n4, n5 in the node set C1 that can be propagated to the next layer, and the calculating method of the layered-search method can be shown in Table 3.

TABLE 3

| i | Lᵢ | Lᵢ₊₁ | V* | sum |
|---|---|---|---|---|
| 1 | {n1} | {n2} | {n1, n2, n3} | 3 |
| 2 | {n2} | {n3, n4} | {n1, n2, n3, n4} | 4 |
| 3 | {n3, n4} | {n4, n5} | {n1, n2, n3, n3, n5} | 5 |

The ith propagation layer is represented as The i+1th propagation layer is represented as Lᵢ₊₁. A feasible propagating node set of the node n1 is represented as V*. The node number of V* is represented as sum. In Table 3, according to the node set C1 of FIG. 5, the propagation-node number of the node n1 is 5. Similarly, in the node set C2 of FIG. 6, the layered-search method can also count the propagation-node number of the node n1 as 4, and so on. The processing unit executes the layered-search method multiple times for the node sets of the node n1, and obtains the propagation-node numbers corresponding to the node n1.

Please refer to the following Table 4. In the expected value generating step S3, the processing unit generates the expected value according to the propagation-node numbers and the propagating success probabilities of the propagation-node numbers of the node n1, and conforms to the following formula (1):

$$E = {\sum }_{i = 1}^{n} i \times \frac{{t}_{i}}{m} = \frac{10 + 4 + 3 + 4 + 4}{10} = \frac{25}{10} = 2.5 . \qquad ( 1 )$$

TABLE 4

| Propagation-node number (i) | times(tᵢ) | ${P}_{i} = \frac{{t}_{i}}{m}$ | i × Pᵢ |
|---|---|---|---|
| 5 | 2 | 2/10 | 10/10 |
| 4 | 1 | 1/10 | 4/10 |
| 3 | 1 | 1/10 | 3/10 |
| 2 | 2 | 2/10 | 4/10 |
| 1 | 4 | 4/10 | 4/10 |

In detail, each of the propagation-node numbers can further include a propagating success time. The processing unit calculates the propagating success probability of each of the propagation-node numbers according to the propagating success time of each of the propagation-node numbers. In more detail, the processing unit repeatedly executes the Monte Carlo Simulation and the layered-search method for 10 times. A number of executions of the Monte Carlo simulation and the layered-search method is represented as m (i.e., m=10). The propagation-node number is represented as i. A number of times is represented as tᵢ (i.e., the propagating success time tᵢ) that the propagation-node number is i in the Monte Carlo Simulation executed m times. The propagating success probability is represented as Pᵢ, and the propagating success probability Pᵢ is the probability that the propagation-node number is i when the Monte Carlo Simulation is executed m times. The propagating success probability P₁ is equal to the propagating success time tᵢ divided by the number of executions m of the Monte Carlo Simulation. The expected value is represented as E. Therefore, the processing unit calculates that the expected value E of the node n1 is 2.5 which represents a node estimating number in the social network 100 to deliver the message to the node n1.

Then, in the target node selecting step S4, the processing unit resets the node n2 as the source node s, and then repeats the probability calculating step n2 and the expected value generating step S3 to generate an expected value of the node n2, and so on to find the rest expected values of the nodes n3, n4, n5. Finally, the processing unit compares the expected values corresponding to the nodes n1, n2, n3, n4, n5 with each other to select the single target node having the maximum expected value.

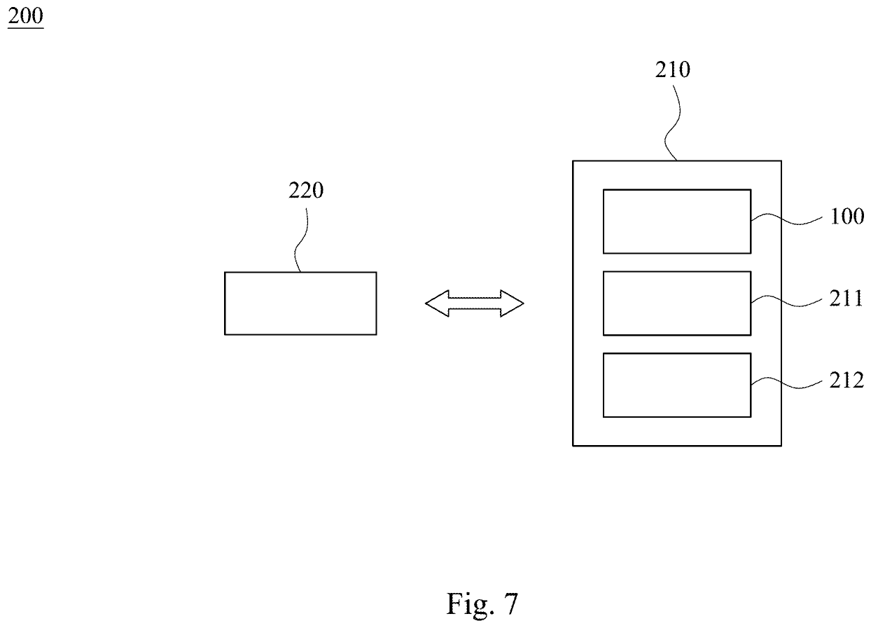

Please refer to FIGS. 1 to 7. FIG. 7 shows a block diagram of a system for the single target node within the social network according to another embodiment of the present disclosure. In FIGS. 1 to 7, the system 200 for selecting the single target node within the social network 100 is configured to select the single target node in the social network 100 and deliver the message. The system 200 for selecting the single target node within the social network 100 includes a memory 210 and a processing unit 220. The memory 210 is configured to access the social network 100, a Monte Carlo module 211 and a layered-search module 212. The social network 100 includes the nodes n1, n2, n3, n4, n5. The processing unit 220 is electrically connected to the memory 210. The processing unit 220 is configured to implement the abovementioned node providing step S1, the probability calculating step S2, the expected value generating step S3 and the target node selecting step S4. The processing unit 220 can be a Micro Processing Unit (MPU), a Central Processing Unit (CPU), a server processor or other arithmetic processors, and the memory 210 can be a memory or other storage data components, but the present disclosure is not limited thereto.

Therefore, the system 200 for selecting the single target node within the social network 100 calculates the expected value of each of the nodes n1, n2, n3, n4, n5 in the social network 100, and selects the single target node having the maximum expected value from the nodes n1, n2, n3, n4, n5 to deliver the message, so that the message in the social network 100 achieves the maximum propagation-node number so as to increase the propagation rate of the message.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A method for selecting a single target node within a social network, which is configured to select the single target node in the social network and deliver a message, and the method for selecting the single target node within the social network comprising:
performing a node providing step to obtain the social network comprising a plurality of nodes and drive a processing unit to set one of the nodes as a source node;
performing a probability calculating step to drive the processing unit to calculate a plurality of propagation-node numbers of the source node according to a Monte Carlo module and a layered-search module, wherein each of the propagation-node numbers is corresponding to a propagating success probability;
performing an expected value generating step to drive the processing unit to generate an expected value according to the propagation-node numbers and the propagating success probabilities of the propagation-node numbers; and
performing a target node selecting step to drive the processing unit to reset another of the nodes as the source node and repeat the probability calculating step and the expected value generating step to generate another expected value, and compare the expected value with the another expected value to select the single target node having a maximum expected value.

2. The method for selecting the single target node within the social network of claim 1, wherein an actual propagating probability between each of the nodes and another of the nodes adjacent to the each of the nodes is generated, and the probability calculating step comprises:
performing a node set generating step, wherein the node set generating step is implemented by the processing unit and comprises:
performing an estimating step to estimate a simulated propagating probability between each of the nodes and another of the nodes adjacent to the each of the nodes according to the Monte Carlo module; and
performing a filtering step to filter the actual propagating probabilities among the nodes according to the simulated propagating probabilities among the nodes to generate a plurality of node sets corresponding to the source node, respectively.

3. The method for selecting the single target node within the social network of claim 2, wherein in response to determining that the actual propagating probability is greater than the simulated propagating probability, the node corresponding to the actual propagating probability propagates the message to another of the nodes.

4. The method for selecting the single target node within the social network of claim 2, wherein the probability calculating step further comprises:
performing a node number calculating step, wherein the node number calculating step is implemented by the processing unit and comprises:
performing a layering step to cut one of the node sets according to the layered-search module to generate an ith propagation layer and an i+1th propagation layer; and
performing an overlying step to overlay the ith propagation layer and the i+1th propagation layer according to the layered-search module to calculate one of the propagation-node numbers.

5. The method for selecting the single target node within the social network of claim 1, wherein each of the propagation-node numbers further comprises a propagating success time, and the processing unit calculates the propagating success probability according to the propagating success times.

6. A system for selecting a single target node within a social network, which is configured to select the single target node in the social network and deliver a message, the system for selecting the single target node within the social network comprising:
a memory configured to access the social network, a Monte Carlo module and a layered-search module, wherein the social network comprises a plurality of nodes; and
a processing unit electrically connected to the memory, wherein the processing unit receives the social network and is configured to implement a method for selecting the single target node within the social network comprising:
performing a node providing step to obtain the social network from the memory and drive the processing unit to set one of the nodes as a source node;
performing a probability calculating step to drive the processing unit to calculate a plurality of propagation-node numbers of the source node according to the Monte Carlo module and the layered-search module, wherein each of the propagation-node numbers is corresponding to a propagating success probability;
performing an expected value generating step to drive the processing unit to generate an expected value according to the propagation-node numbers and the propagating success probabilities of the propagation-node numbers; and
performing a target node selecting step to drive the processing unit to reset another of the nodes as the source node and repeat the probability calculating step and the expected value generating step to generate another expected value, and compare the expected value with the another expected value to select the single target node having a maximum expected value.

7. The system for selecting the single target node within the social network of claim 6, wherein an actual propagating probability between each of the nodes and another of the nodes adjacent to the each of the nodes is generated, and the probability calculating step comprises:
performing a node set generating step, wherein the node set generating step is implemented by the processing unit and comprises:
performing an estimating step to estimate a simulated propagating probability between each of the nodes and another of the nodes adjacent to the each of the nodes according to the Monte Carlo module; and
performing a filtering step to filter the actual propagating probabilities among the nodes according to the simulated propagating probabilities among the nodes to generate a plurality of node sets corresponding to the source node, respectively.

8. The system for selecting the single target node within the social network of claim 7, wherein in response to determining that the actual propagating probability is greater than the simulated propagating probability, the node corresponding to the actual propagating probability propagates the message to another of the nodes.

9. The system for selecting the single target node within the social network of claim 7, wherein the probability calculating step further comprises:
performing a node number calculating step, wherein the node number calculating step is implemented by the processing unit and comprises:
performing a layering step to cut one of the node sets according to the layered-search module to generate an ith propagation layer and an i+1th propagation layer; and
performing an overlying step to overlay the ith propagation layer and the i+1th propagation layer according to the layered-search module to calculate one of the propagation-node numbers.

10. The system for selecting the single target node within the social network of claim 6, wherein each of the propagation-node numbers further comprises a propagating success time, and the processing unit calculates the propagating success probability according to the propagating success times.
